(19) United States
(12) Patent Application Publication
(10) Pub. No.: US 2004/0199994 A1
(43) Pub. Date: Oct. 14, 2004

(54) Pedicure tub liner

(76) Inventors: Fatima Sherif, Marina Del Rey, CA (US); Elizabeth A. Rudolph, Marina Del Rey, CA (US)

Correspondence Address: DIEDERIKS & WHITELAW, PLC, 12471 Dillingham Square, #301, Woodbridge, VA, 22192, US

(21) Appl. No.: 10/819,914

(22) Filed: Apr. 8, 2004

Related U.S. Application Data
(60) Provisional application No. 60/461,411, filed on Apr. 10, 2003.

(51) Int. Cl. A47K 3/022; E03C 1/00; A61H 35/00

(52) U.S. Cl. 4/622

(57) ABSTRACT

A disposable liner is positioned within a foot/pedicure tub to protect clients from risks associated with unsanitary tubs. The foot tub includes an upper peripheral edge portion and an interior portion having a two-tiered foot platform molded therein. The disposable liner includes an elastic or drawstring band that fits snugly around and can be hidden under the upper peripheral edge portion of the foot tub. In addition, the disposable liner includes a plastic portion covering the interior portion of the foot tub. The plastic portion of the liner is shaped to conform to the two-tiered foot platform of the foot tub. When a pedicure is complete, a used liner may be easily removed and disposed of and a new liner may be arranged to prepare for the next client.

### CROSS-REFERENCE TO RELATED APPLICATIONS

The present application claims the benefit of U.S. Provisional Patent Application Serial No. 60/461,411 filed Apr. 10, 2003.

### BACKGROUND OF THE INVENTION

1. Field of the Invention

The present invention pertains to the art of pedicure tubs and, more specifically, to a liner for a pedicure tub.

2. Discussion of the Prior Art

Pedicure treatments have become very common in many salons and spas. Typically, at the start of a pedicure, a client's feet are soaked in a warm foot bath to soften the skin on the feet. After several minutes of soaking, the feet are scrubbed and calluses are removed. In addition, the toe nails are trimmed and groomed. The feet are then soaked in the foot bath again to further cleanse the feet.

Salons and spas treat a large number of clients daily. However, some clients are reluctant to treat themselves to a pedicure at a spa or salon because of the risks associated with receiving a foot bath in a tub used by other clients. Some risks that may be linked to salon foot tubs include the risk of contracting athlete's foot, planter's warts, and other foot fungus.

Although salons and spas may clean foot tubs between clients, many clients still consider the risks associated with the foot tubs to outweigh the benefits of pedicures. In addition, the time and costs associated with thoroughly cleaning pedicure tubs between clients are considered quite unattractive. Based on the above, there exists a need for a way to quickly and easily sanitize a foot tub for use by consecutive clients in salons and spas.

### SUMMARY OF THE INVENTION

The present invention is directed to a disposable liner for a pedicure or foot tub. The foot tub includes an upper peripheral edge portion and an interior portion preferably having a multi-tiered foot platform molded therein. The disposable liner includes an elastic or drawstring band that fits snugly around and may be hidden under the upper peripheral edge portion of the foot tub. In addition, the disposable liner includes a plastic or other impermeable main body portion covering the interior portion of the foot tub. The main body portion of the liner is shaped to conform to the foot tub. The liner also includes contour sections that correspond to the foot platforms or other structures within the foot tub. Therefore, each liner is preferably constructed to follow the contours of the particular foot tub for which it is designed. When a pedicure is complete, a used liner may be easily removed and disposed of and a new liner may be arranged to prepare for the next client.

Additional objects, features and advantages of the present invention will become more readily apparent from the following detailed description of a preferred embodiment when taken in conjunction with the drawings, wherein like reference numerals refer to corresponding parts in the several views.

### BRIEF DESCRIPTION OF THE DRAWINGS

FIG. 1 is an exploded view of a first embodiment of the disposable liner and foot tub of the present invention;

FIG. 2 is a perspective view of the liner and foot tub of FIG. 1 with the liner positioned within the tub;

FIG. 3 is an exploded view of a second embodiment of the disposable liner and foot tub of the present invention; and

FIG. 4 is a perspective view of the liner and foot tub of FIG. 3 with the liner positioned within the tub.

### DETAILED DESCRIPTION OF THE PREFERRED EMBODIMENT

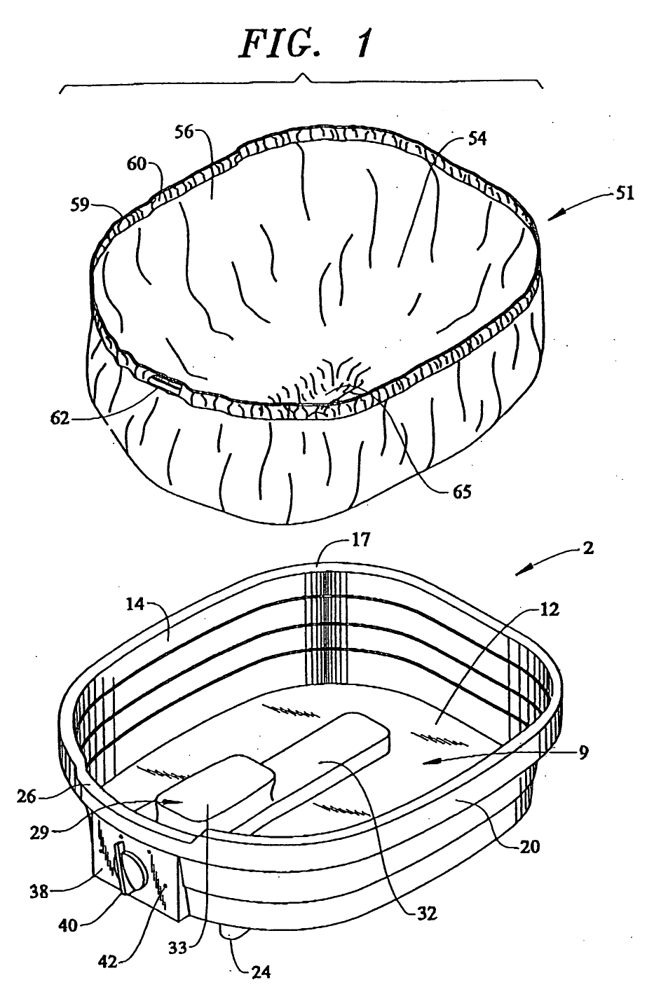

With initial reference to FIG. 1, the present invention is shown in combination with a pedicure foot tub 2. Initially, it should be noted that various types of foot tubs are available in the market place and FIG. 1 illustrates one known type of tub sold under the trade name HELEN OF TROY. As shown, foot tub 2 includes an interior portion 9 that is defined by a bottom 12 and an annular side wall 14. Annular side wall 14 terminates in an upper peripheral edge portion 17. In accordance with this known foot tub 2, annular side wall 14 is tiered such that, on an outer portion of foot 2, upper peripheral edge portion 17 leads to a lip 20 that defines an undercut. Foot tub 2 includes a plurality of legs, one of which is indicated at 24, which extend from bottom 12 for supporting foot tub 2 on a planar surface.

Upper peripheral edge portion 17 of foot tub 2 is shown to include a frontal notch 26 which is in line with an interior pedestal 29. In accordance with this known foot tub 2, interior pedestal 29 includes a lower platform 32 extending from bottom 12 and an upper platform 33. In general, platforms 32 and 33 are adapted to support a user's foot such that a technician can perform a series of pedicure operations. Arranged below frontal notch 26 is a face plate portion 38 which is provided with a rotary control knob 40. Face plate portion 38 includes various indicia or markings 42. In general, in a manner known in the art, foot tub 2 incorporates a heater and/or massage mechanism (not shown) such that control knob 40 is used to selectively control the activation/deactivation state of these mechanisms. For this purpose, foot tub 2 would also include a power cord (not shown) which is adapted to be plugged into a conventional outlet.

Again, the structure and operation of foot tub 2 is known in the art and therefore will not be detailed further here. Instead, the present invention is particularly directed to the use of a disposable liner, generally indicated at 51, for use in connection with foot tub 2. As will be detailed more fully below, liner 51 is specifically shaped to match the contours of foot tub 2, which minimizes potential piercings of liner 51 during the course of a pedicure and provides an overall professional configuration. In any event, liner 51 includes a bottom 54 and an annular side wall 56. Annular side wall 56 terminates in an upper edge portion 59 which generally defines a circumferential sleeve 60. Arranged within sleeve 60 is a band 62 formed from an elastomeric material.

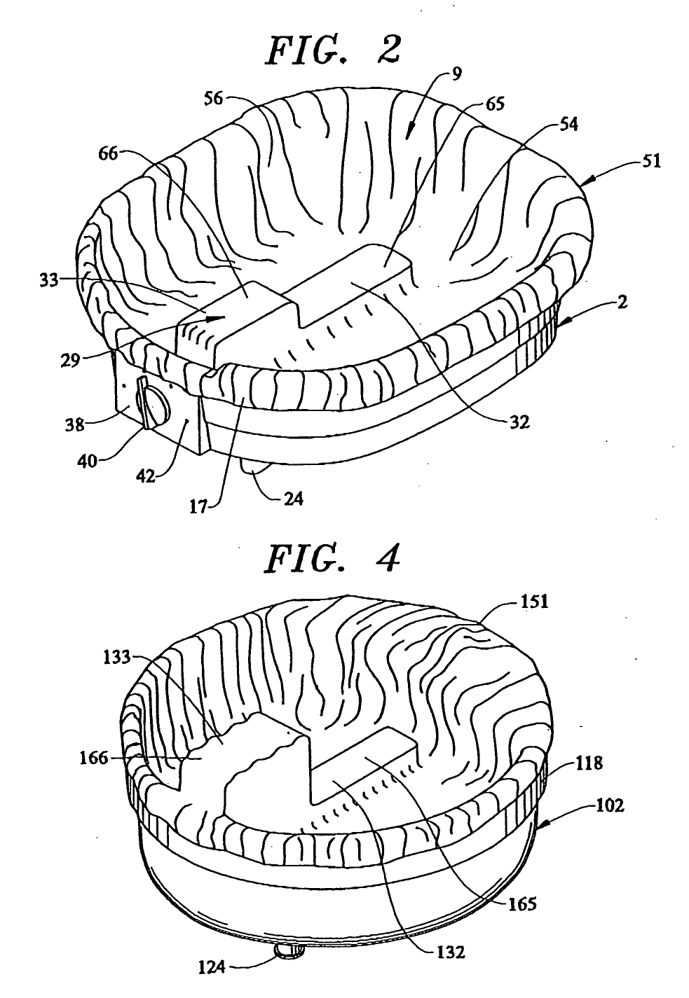

As indicated above, liner 51 is preferably constructed to follow the contours of the particular foot tub 2 for which it is designed. To this end, bottom 54 is provided with additional contour sections 65 and 66 (also see FIG. 2), with these additional contour sections 65 and 66 generally being defined by additional material positioned in strategic locations in correspondence to the structure of foot tub 2. That is, with particular reference to FIG. 2, when liner 51 is placed within foot tub 2, bottom 54 of liner 51 extends along bottom 12 of foot tub 2, while additional contour sections 65 and 66 snugly accommodate platforms 32 and 33. Annular side wall 56 of liner 51 extends up the annular side wall 14 of foot tub 2, while also extending over upper peripheral edge portion 17. More specifically, annular side wall 56 extends entirely over upper peripheral edge portion 17 until sleeve 60 is arranged beneath the under cut defined by lip 20. At this point, band 62 is expanded such that upper edge 59 tightly extends about annular side wall 14 of foot tub 2 to securely retain liner 51 within interior portion 9. A bathing material can then be supplied into liner 51 within interior portion 9 for a pedicure procedure. Since contour sections 65 and 66 extend snugly around platforms 32 and 33, platforms 32 and 33 can be utilized in a conventional manner. Once the pedicure is complete, the water is drained from foot tub 2 and liner 51 is disposed of.

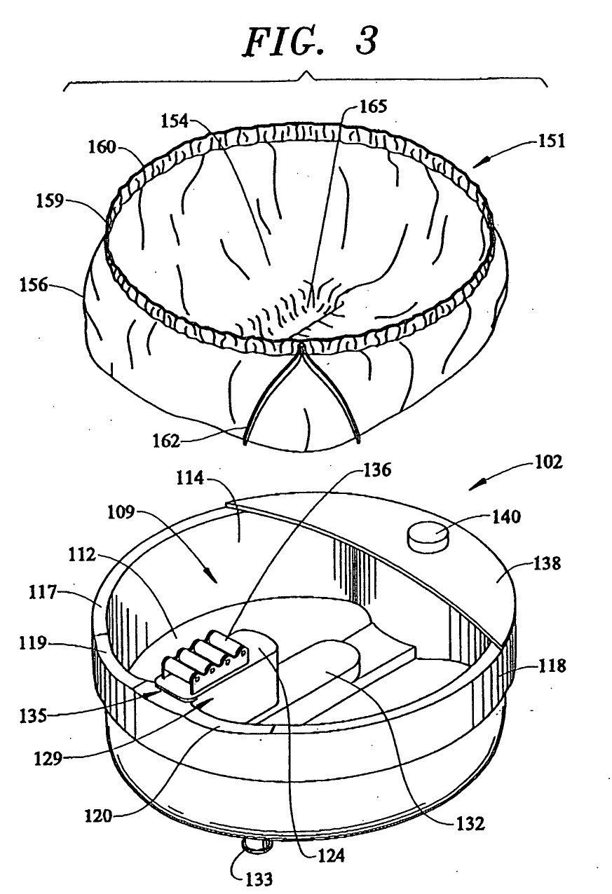

Again, foot tub 2 takes the form of one commonly known type of pedicure tub employed in the industry. FIG. 3 illustrates another known foot tub 102 which is sold under the trademark JILBERE de PARIS. In manner similar to foot tub 2, foot tub 102 includes an interior portion 109 that is defined by a bottom 112 and an annular side wall 114. It should be noted that, whereas foot tub 2 is generally rectangular, foot tub 102 is is generally circular. In accordance with foot tub 102, annular side wall 114 includes an upper peripheral edge portion 117 and an outer rim 118. Similar to foot tub 2, foot tub 102 includes a plurality of legs, one of which is indicated at 124, which extends from bottom 112 for supporting foot tub 102 on a planar surface.

Foot tub 102 is shown to include spaced indents 119 and 120 along upper peripheral edge portion 117. An interior pedestal 129 is positioned within interior portion 109 between frontal indents 119 and 120. In accordance with this known foot tub 102, interior pedestal 129 includes a lower platform 132 extending from bottom 112 and an upper platform 133. In a manner corresponding to platforms 32 and 33 of the FIGS. 1 and 2 embodiment described above, platforms 132 and 133 are adapted to support a user's foot such that a technician can perform a series of pedicure procedures. A foot massaging device 135 is also shown mounted on upper platform 133. Foot massaging device 135 includes a plurality of rolling cylinders 136 which are used to massage the underside of a user's foot. A cover 138 extends across a portion of foot tub 102. Cover 138 includes a control knob 140 which is used to selectively control the activation/deactivation of a heater and/or massage mechanism (not shown). As with foot tub 2, foot tub 102 includes a power cord (not shown) adapted to be plugged into a conventional outlet.

In a manner similar to foot tub 2, the structure and operation of foot tub 102 is known in the art and therefore will not be detailed further here. Instead, the present invention is particularly directed to the use of a disposable liner, generally indicated at 151, for use in connection with foot tub 102. Liner 151, which is shaped to match the contours of foot tub 102, includes a bottom 154 and an annular side wall 156. Annular side wall 156 terminates in an upper edge portion 159 which generally defines a circumferential sleeve 160. A drawstring 162 is arranged within sleeve 160 for securing liner 151 to foot tub 102. Again, liner 151 is constructed to follow the contours of foot tub 102. Therefore, bottom 154 of liner 151 includes contour sections 165 and 166 (shown in FIG. 4). With particular reference to FIG. 4, when liner 151 is placed within foot tub 102, bottom 154 of liner 151 extends along bottom 112 of foot tub 102, while contour sections 165 and 166 snugly accommodate platforms 132 and 133. As shown, liner 151 may also accommodate massage device 135 on platform 133. Annular side wall 156 of liner 151 extends along annular side wall 114 of foot tub 102, while also extending over upper peripheral edge portion 117 until upper edge portion 159 is arranged on outer rim 118 as shown in FIG. 4. At this point, drawstring 162 is pulled such that upper edge 159 tightly extends about annular side wall 114 of foot tub 102 to securely retain liner 151 within interior portion 109. Liner 151 may then be filled with water for a pedicure procedure. Once the pedicure is complete, the water is drained from foot tub 102 and liner 151 is disposed of.

In accordance with the most preferred forms of the invention, liners 51 and 151 are formed of a plastic material so as to be completely waterproof. Based on the above, a new liner 51, 151 will be utilized for each pedicure procedure thereby providing a client with the security of knowing that sanitary conditions exist. Again, in accordance with the preferred embodiments, liners 51 and 151 are constructed so as to conform to the particular foot tub 2, 102 being employed. Of course, it would be possible to simply provide additional material associated with bottom 54 or 154 in order that the additional material could extend around the contours of a respective tub 2, 102, while perhaps bagging up along bottom 12 or 112. However, in accordance with the most preferred form of the invention, contour sections 65, 66, 165, 166 are provided in order to ensure the structural integrity of liners 51 and 151 during use and to provide a much more professional, overall appearance, particularly given the nature of the invention and the clientele associated therewith.

Although described with reference to a preferred embodiment of the invention, it should be readily understood that various changes and/or modifications can be made to the invention without departing from the spirit thereof. In general, the invention is only intended to be limited by the scope of the following claims.

I claim:

1. A foot tub for performing a pedicure comprising:
an interior portion defined by a bottom, an annular side wall and a foot platform, said annular side wall terminating in an upper peripheral edge portion; and
a disposable liner including a band that fits snugly around said upper peripheral edge portion of the foot tub and an impermeable main body portion for covering the interior portion of the foot tub, wherein the impermeable main body portion includes at least one contour section shaped to conform to the foot platform.

2. The foot tub according to claim 1, wherein the impermeable main body portion is made of plastic.

3. The foot tub according to claim 1, wherein the band is made of elastic.

4. The foot tub according to claim 1, wherein the band constitutes a drawstring.

5. The foot tub according to claim 1, wherein the disposable liner includes a sleeve portion, said band being located within the sleeve portion.

6. The foot tub according to claim 1, wherein the foot platform includes an upper tier and a lower tier, the at least one contour section of said disposable liner conforming to each of the upper and lower tiers.

7. The foot tub according to claim 6, further comprising: a foot messaging device including a plurality of rollers mounted on one of the upper and lower tiers, said disposable liner extending over the plurality of rollers.

8. A disposable liner for a foot tub having an upper peripheral edge portion and an interior portion having a foot platform provided therein, said disposable liner comprising:
a band adapted to fit snugly around the upper peripheral edge portion of the foot tub; and
an impermeable main body portion for covering the interior portion of the foot tub, wherein the impermeable main body portion includes contour sections which are shaped to conform to the foot platform.

9. The disposable liner according to claim 8, wherein the impermeable main body portion is made of plastic.

10. The disposable liner according to claim 8, wherein the band is made of elastic.

11. The disposable liner according to claim 8, wherein the band constitutes a drawstring.

12. The disposable liner according to claim 8, further comprising: a sleeve portion, said band being located within the sleeve portion.

13. A method of performing a pedicure comprising:
lining an interior portion of a foot tub with a main body portion of an impermeable liner, with at least one contour section of the liner conforming to a foot platform provided as part of the foot tub;
positioning a band provided about the main body portion of the liner snugly around an upper peripheral edge of the foot tub;
introducing water to the foot tub;
performing a pedicure utilizing the water in the foot tub;
removing the liner from the foot tub; and
discarding the liner for sanitation purposes.

14. The method of claim 13, further comprising: aligning the liner such that the at least one contour section snugly conforms to upper and lower tiers of the foot platform.

15. The method of claim 13, further comprising: covering foot massaging rollers, provided on the foot platform, with the liner.

16. The method of claim 13, further comprising: pulling a drawstring of the band to secure the band under the upper peripheral edge of the foot tub.

17. The method of claim 16, further comprising: pulling the drawstring from within a sleeve formed about the main body portion of the liner.

18. The method of claim 13, further comprising: hiding the band under the upper peripheral edge of the foot tub.
